(19) United States
(12) Patent Application Publication
(10) Pub. No.: US 2006/0239123 A1
(43) Pub. Date: Oct. 26, 2006

(54) DAYLIGHT SAVING TIME AUTOMATIC ADJUSTMENT METHOD AND TIMEPIECE USING SAME

(75) Inventor: Chih-Yuh Chen, Taipei City (TW)

Correspondence Address: GLACIALTECH, INC., P. O. BOX 108-00403, TAIPEI, TW

(73) Assignee: DUTECK INDUSTRIAL CO., LTD., Taipei City (TW)

(21) Appl. No.: 11/428,565

(22) Filed: Jul. 4, 2006

Related U.S. Application Data
(63) Continuation-in-part of application No. 10/788,011, filed on Feb. 27, 2004.

(51) Int. Cl. G04B 19/22

(52) U.S. Cl. 368/21

(57) ABSTRACT

A timepiece time having installed in the movement thereof a CPU, a time zone adjustment device and a time display unit, the CPU having installed therein a perpetual calendar program, a time zone calculation program, and a daylight saving time calculation program, the time zone adjustment device being operable to input a time zone signal to the CPU for enabling the time zone calculation program to calculate the conversion time corresponding to the set time zone and for enabling the daylight saving time calculation program to determine whether the set time zone has applied daylight saving time, such that the time display unit is controllable by the CPU to automatically adjust displayed time and to automatically enter/withdraw from the daylight saving time cycle of the corresponding time zone subject to calculation of the time zone calculation program and the daylight saving time calculation program.

This application is a Continuation-In-Part of my patent application, Ser. No. 10/788,001, filed on Feb. 27, 2004.

### BACKGROUND OF THE INVENTION

1. Field of the Invention:

The present invention relates to timepieces and more particularly, to a daylight saving time automatically adjustable timepiece that is controllable to automatically enter or withdraw from the daylight saving time cycle defined by the respective time zone subject to one single setting by the user.

2. Description of the Related Art:

Following fast development of transportation, people have much chance of traveling abroad. However, the time in one country may differ from that in the other. In order to eliminate this problem, the Earth is geometrically subdivided into 24 time zones based their time on Greenwich Mean Time, the mean solar time at longitude 0° (the Prime Meridian). The local time in neighbouring zones is exactly one hour different.

Further, following fast development of network and communication technology, people may need to know the time of a time zone at the other side of the Earth. More particularly, financial futures exchange traders or brokers must know the opening and closing time of the market in every country because a small mistake may result in a terrible loss. Therefore, timepieces that are adjustable to fit different time zones are created. FIGS. 1 and 2 show a timepiece of this design. As illustrated, the timepiece has a dial 92 arranged around the time display unit 91 (hour hand, minute hand and second hand). The dial 92 is divided into 24 blocks corresponding to the 24 time zones. When rotated through one block, the timepiece is adjusted to a next time zone, and the internal mechanical mechanism moves the hour hand 1 hour forwards or backwards, showing 1 hour time difference between two neighbouring time zones.

Further, there are about 70 countries that apply daylight saving time. However, these countries belong to different time zones that are different in time and date. For example, the application date of daylight saving time in German is different from that in Australia. Commercial time zone-adjustable timepieces do not provide a daylight saving time adjustment function. When visiting another time zone or country, the user must check the local daylight saving time and then adjust the timepiece manually subject to the local daylight saving time. Therefore, these conventional timepieces do not have the function of automatically adjusting daylight saving time.

Further, there is known a radio control clock controllable by a radio signal from a base station. This design of radio control clock can directly display the daylight saving time of every country. However, because radio signal may be blocked or caused to attenuate by shelter means, the radio control clock may be unable to receive the signal accurately or stably.

Therefore, it is desirable to provide a timepiece that eliminates the aforesaid problems.

### SUMMARY OF THE INVENTION

The present invention has been accomplished under the circumstances in view. According to the present invention, when the user adjusts a time zone adjustment device of the timepiece to input a time zone signal to a central processing unit in the movement of the timepiece subject to the selected time zone, the time zone calculation program calculates the conversion time, and the daylight saving time calculation program of the central processing unit judges whether the selected time zone has applied daylight saving time or not. Thereafter, the time display unit is controlled by the central processing unit to automatically adjust displayed time and to automatically enter/withdraw from the daylight saving time cycle of the corresponding time zone subject to calculation of the time zone calculation program and the daylight saving time calculation program.

### BRIEF DESCRIPTION OF THE DRAWINGS

FIG. 1 is a perspective view of a timepiece according to the prior art.

FIG. 2 is a schematic front view of the timepiece according to the prior art.

FIG. 3 is a system block diagram of the preferred embodiment of the present invention.

FIG. 4 is a time zone-contact conversion table according to the present invention.

FIG. 5 is a perspective view of a timepiece according to the present invention.

FIG. 6 is a flowchart explaining the operation of the daylight saving time calculation program according to the present invention.

### DETAILED DESCRIPTION OF THE PREFERRED EMBODIMENT

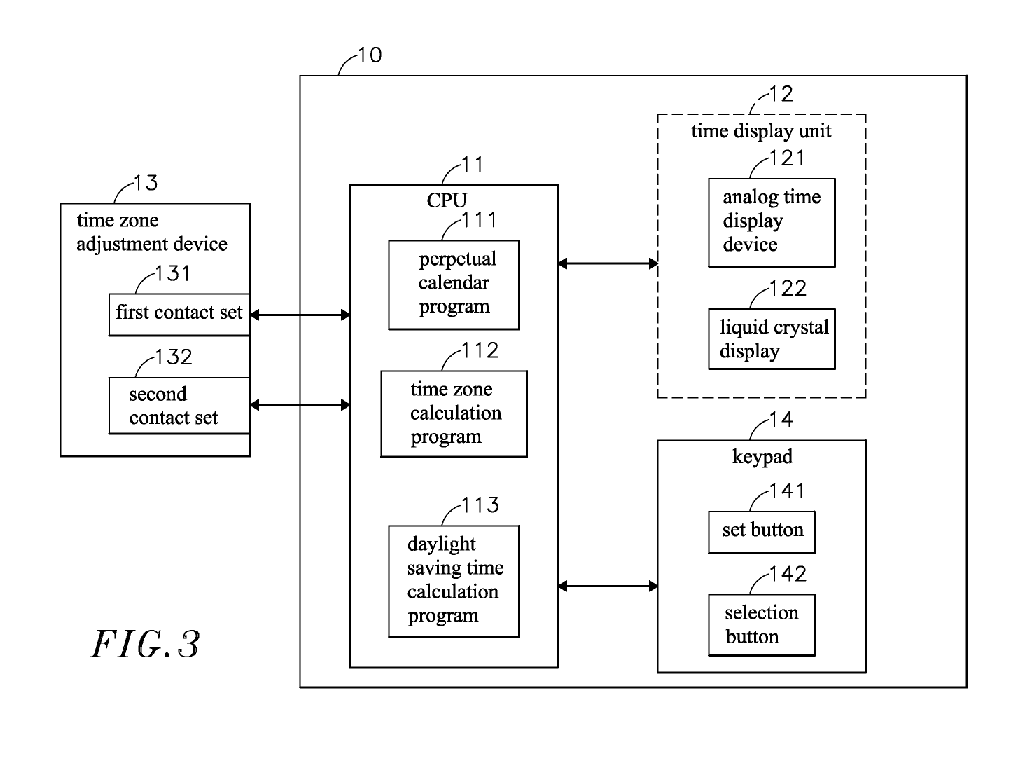

Referring to FIG. 3, a timepiece in accordance with the present invention is shown having a CPU (Central Processing Unit) 11, a time display unit 12 and a time zone adjustment device 13 installed in the movement 10.

The CPU 11 is a programmable operating unit adapted to control the time display unit 12 to display the set time and date, having installed therein a perpetual calendar program 111, a time zone calculation program 112 and a daylight saving time calculation program 113. The perpetual calendar program 111 includes calculation of leap year or leap month. After reset of the timepiece, the user can set the current time and date and compare the setting to the perpetual calendar program 111 so that the time display unit 12 displays the accurate time and date. The time zone calculation program 112 is adapted to calculate the conversion time corresponding to every time zone subject to the setting of the time zone adjustment device 13. The daylight saving time calculation program 113 has set therein the daylight saving time definition of every country in every time zone.

The time display unit 12 adjusts displayed time subject to the signal transmitted from the CPU 11. The time display unit 12 comprises an analog time display device 121 or a liquid crystal display 122.

The time zone adjustment device 13 can be attached to or built in the movement 10. The time zone adjustment device 13 can be operated to input the set time zone signal into the CPU 11, causing the time zone calculation program 112 of the CPU 11 to calculate the conversion time.

Further, the aforesaid analog time display device 121 can be controlled to adjust rotation of the hour hand, minute hand and second hand through an adjustment knob (not shown) so as to indicate time accurately. Alternatively, a synchronous motor and transmission gear set (not shown) can be built in the analog time display device 121 to adjust rotation of the hour hand, minute hand and second hand so as to indicate time accurately. When the analog time display device 121 received a setting signal from the CPU 11, the synchronous motor and transmission gear set are immediately started to adjust the hour hand, minute hand and/or second hand to indicate time accurately. Further, the adjustment of the display of time on the liquid crystal display 122 is achieved through a set button 141 and a selection button 142 of a keypad 14. The set time signal is sent by the keypad 14 to the CPU 11, causing the liquid crystal display 122 to display time accurately.

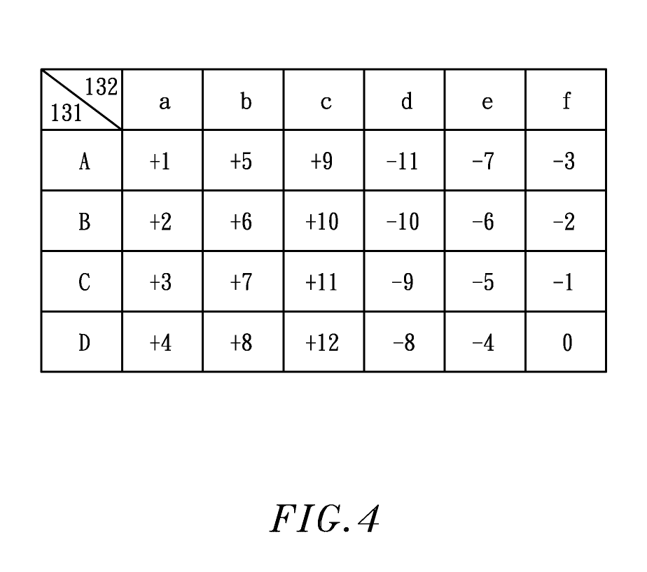

Further, the time zone adjustment device 13 has a first contact set 131 and a second contact set 132 electrically connected to the CPU 11. The first contact set 131 has four contacts. The second contact set 132 has six contacts. When adjusting the time zone adjustment device 13, one of the contacts of the first contact set 131 and one of the contacts of the second contact set 132 are selectively connected to the CPU 11, providing one of twenty four time zone signals to the CPU 11. As shown in FIG. 4, the four contacts of the first contact set 131 are respectively referenced by A, B, C and D; the six contacts of the second contact set 132 are respectively referenced by a, b, c, d, e and f. For example, when the first contact A of the first contact set 131 and the first contact a of the second contact set 132 are selected and electrically connected to the CPU 11, the time zone adjustment device 13 provides +1 time zone signal to the time zone calculation program 112 of the CPU 11 for calculation; when the third contact C of the first contact set 131 and the sixth contact f of the second contact set 132 are selected and electrically connected to the CPU 11, the time zone adjustment device 13 provides −1 time zone signal to the time zone calculation program 112 of the CPU 11 for calculation. The rest can be done in the same manner. Therefore, the time zone adjustment device 13 can be operated to provide one of total 24 time zone signals.

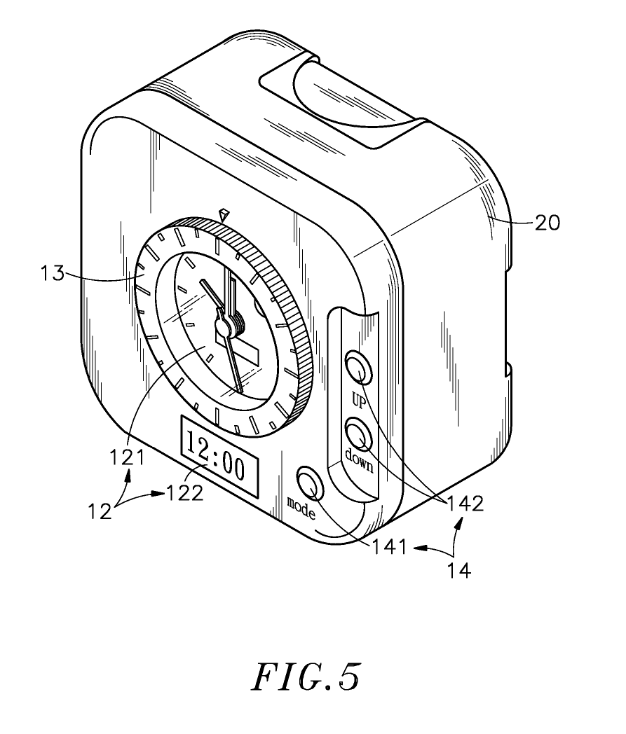

Referring to FIG. 5, the movement 10 is mounted in a housing 20. The time display unit 12 and the keypad 14 are exposed to the outside of the housing 20. The analog time display device 121 of the time display unit 12 is disposed at the center of the front side of the housing 20. The time zone adjustment device 13 is disposed around the analog time display device 121. According to this embodiment, the time zone adjustment device 13 is an annular dial marked with 24 graduations corresponding to 24 time zones and rotatable step by step. When the user rotated the time zone adjustment device 13 to the desired time zone, press the set button 141 of the keypad 14 to finish the setting. At this time, the keypad 14 outputs a corresponding time zone signal to the time zone calculation program 112 of the CPU 11 for calculation. This structural design prevents an error action when the time zone adjustment device 13 is moved accidentally. Further, the liquid crystal display 122 is provided at the bottom side of the analog time display device 121 for displaying digital data.

When using the timepiece at the first time, insert battery (not shown) into the battery holder (not shown) in the housing 20. At this time, the liquid crystal display 122 displays the sign of “SETUP”, and then the procedure of zeroing the reading can be done. This procedure of zeroing the reading includes the step of pressing the selection button 142 to zero the reading of the liquid crystal display 122 and the step of rotating the adjustment knob of the analog time display device 121 at the back side of the housing 20 (not shown) to turn the hour hand, the minute hand and the second hand to the vertically upwardly extending position, i.e., to aim the hands at the 12:00 position.

After zeroed the reading, press the set button 141. At this time, the liquid crystal display 122 displays the sign of DST/ON (daylight saving time is on). If the country or time zone where the timepiece is used does not daylight saving time, press the selection button 142 to switch DST/ON (daylight saving time is on) to DST/OFF (daylight saving time is off). Thus, the user can select to switch on/off daylight saving time when in the daylight saving time cycle.

Thereafter, the user can start time setting and operate the selection button 142 to select the accurate year, month, date, hour, minute and second, and then press the set button 141 to finish the setting. When the set button 141 is pressed, a corresponding time signal indicative of the inputted time and date is provided to the perpetual calendar program 111 of the CPU 11 for comparison so that the accurate date and time are displayed, eliminating the procedure of adjusting the date or the year due to a big or small month, or a leap year.

After time setting, the liquid crystal display 122 displays the accurate date and time, and the CPU 11 drives the synchronous motor and transmission gear set to move the hour hand, minute hand and second hand of the analog time display device 121, thereby synchronizing the display of time of the analog time display device 121 and the display of time of the liquid crystal display 122.

If the user wishes to display the time of a different time zone, adjust the time zone adjustment device 13 and the keypad 14 to set the time zone or city and then select the daylight saving time setting to the setting of DST/ON or DST/OFF. After the setting, a corresponding signal is provided to the CPU 11 for calculation by the time zone calculation program 112 and the daylight saving time calculation program 113. After the calculation, the CPU 11 outputs a corresponding signal to control the analog time display device 121 and the liquid crystal display 122 to display time subject to the related setting.

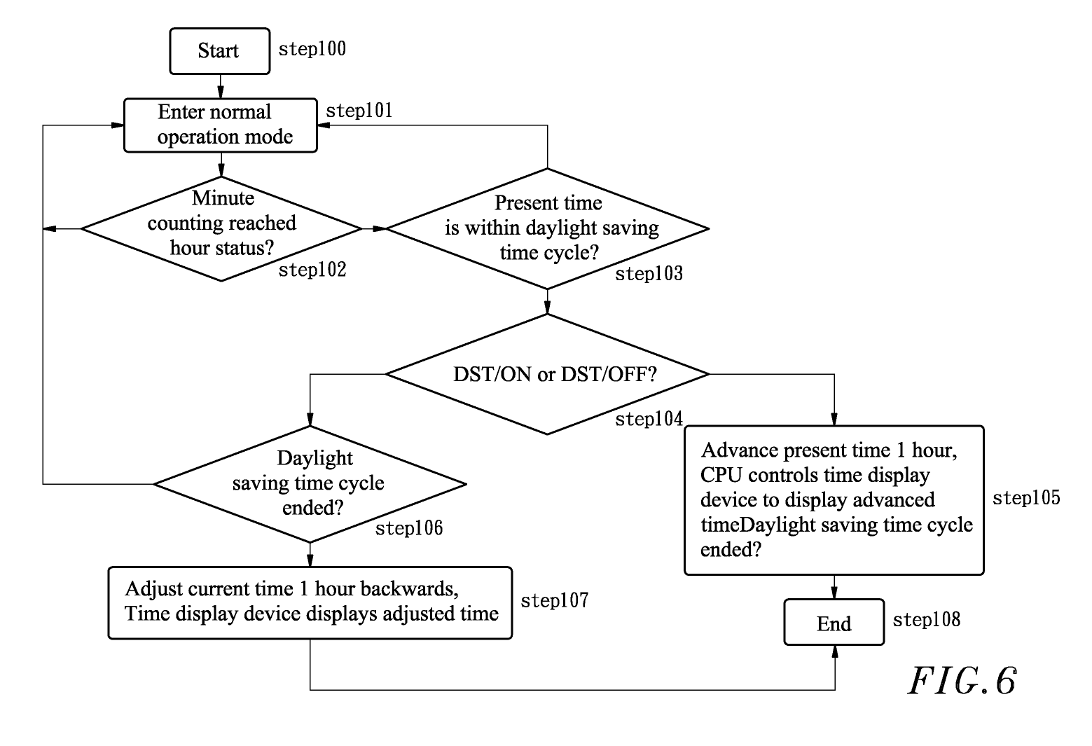

Referring to FIG. 6 and FIG. 3 again, after the setting of zeroing the reading, the setting of time and the setting of time zone adjustment, the daylight saving time calculation program 113 judges if the present time zone has applied daylight saving time or not, and then starts the following steps:
(100) Start;
(101) Enter normal operation mode;
(102) Judge if minute counting has reached hour status or not, and then proceed to step (103) if positive, or return to step (101) if negative;
(103) Judge if the current time and date are in the daylight saving time cycle or not, and then proceed to step (104) if positive, or step (106) if negative;
(104) Determine if to switch on or switch off the setting of daylight saving time, and then proceed to step (105) when DST/ON, or step (106) when DST/OFF;
(105) Advance the present time 1 hour, for enabling the CPU 11 to control the time display unit 12 to display the advanced time, and then proceed to step (108);
(106) Judge, subject to the currently running time and date, if the daylight saving time cycle has been ended or not, and then proceed to step (107) if positive, or return to step (101) if negative;
(107) Adjust current time 1 hour backwards for enabling the time display unit 12 to display adjusted time, and then enter step (108);
(108) End the procedure.

Therefore, after the user has zeroed the reading, set the time and adjusted the time zone, the daylight saving time calculation program 113 starts the calculation to automatically adjust the daylight saving time of the local time zone, for example, to define the USA daylight saving time cycle to be started from 02:00 of the first Sunday in April of each year and ended by 02:00 of the last Sunday in October of the same year. If the set time is not within the daylight saving time cycle, the program keeps running steps (101), (102) and (103), and will proceed to step (104) to make daylight saving time calculation only when entered the daylight saving time cycle. Therefore, in addition to calculating the conversion time subject to the inputted time zone signal, the CPU 11 will also add daylight saving time and control the time display unit 12 to automatically adjust the setting, so as to automatically enter or withdraw from the daylight saving time cycle.

Further, if the time zone set by the time zone adjustment device 13 does not apply daylight saving time, directly search the conversion time subject to the calculation of the time zone calculation program 112.

As indicated above, the daylight saving time automatic adjustment method and timepiece using same of the present invention has benefits as outlined hereinafter.

When in use, it needs only to make the setting once. After the setting, the timepiece automatically adjusts the corresponding time and date subject to the defined daylight saving time. During setting, the user can make zero reading calibration by moving the hour hand, minute hand and second hand of the analog time display device 121 to 12:00 position, or zero the reading of the liquid crystal display 122. After zeroed the reading, the user simply needs only to set the time and date once by means of the adjustment knob of the analog time display device 121 or the keypad 14. After setting, the set time signal is sent to the perpetual calendar program 111 of the CPU 11 for comparison, so that the timepiece accurately display time and date, eliminating the problem of adjusting the date or the year due to a big or small month, or a leap year, After setting of time, date and time zone by the user, the daylight saving time calculation program 113 automatically judges whether the present time zone has applied daylight saving time or not, and also judges whether the present time zone is within the daylight saving time cycle or not. Thus, the timepiece automatically enters or withdraws from the daylight saving time cycle of the respective time zone, and automatically adjusts the time display unit 12 to display accurate time and date.

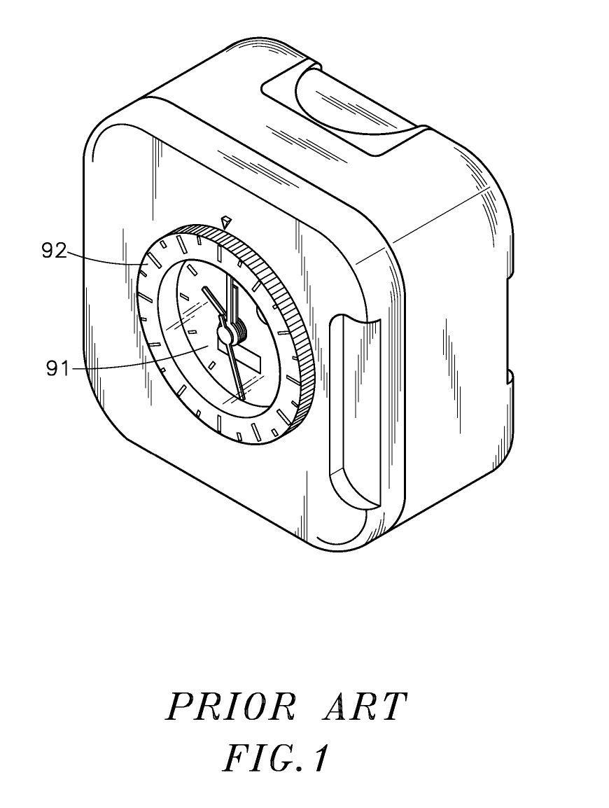

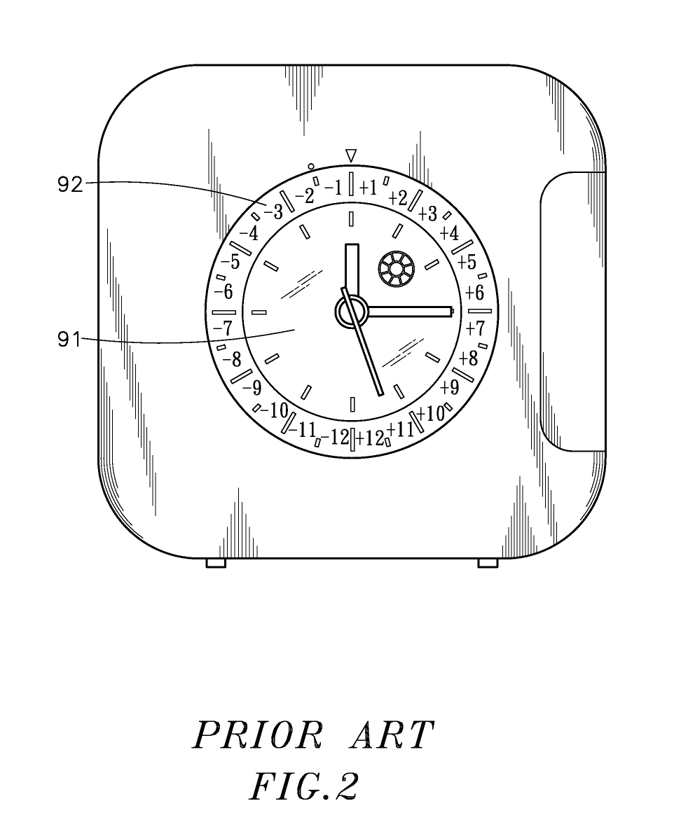

A prototype of the daylight saving time automatic adjustment method and timepiece using same has been constructed with the features of FIGS. 1-6. The daylight saving time automatic adjustment method and timepiece using same functions smoothly to provide all of the features discussed earlier.

Although a particular embodiment of the invention has been described in detail for purposes of illustration, various modifications and enhancements may be made without departing from the spirit and scope of the invention. For example, if the timepiece is to be used in one specific time zone only, the time zone adjustment device 13 can be eliminated. In this case, entering or withdrawing from the daylight saving time cycle is determined subject to the calculation of the daylight saving time calculation program 113 of the CPU 11. Accordingly, the invention is not to be limited except as by the appended claims.

What the invention claimed is:

1. A timepiece having installed in a movement thereof a central processing unit, a time zone adjustment device and a time display unit, wherein:
said central processing unit has installed therein a perpetual calendar program, a time zone calculation program, and a daylight saving time calculation program:
said time zone adjustment device is operable to input one of a set of time zone signals to said central processing unit for enabling said time zone calculation program of said central processing unit to calculate the conversion time corresponding to the set time zone and for enabling said daylight saving time calculation program to determine whether the set time zone has applied daylight saving time;
said time display unit is controllable by said central processing unit to automatically adjust displayed time and to automatically enter/withdraw from the daylight saving time cycle of the corresponding time zone subject to calculation of said time zone calculation program and said daylight saving time calculation program.

2. The timepiece as claimed in claim 1, wherein said perpetual calendar program of said central processing unit includes calculation of leap year/leap month such that when the user sets the present time and date after zeroed the reading of the timepiece, the setting is compared to said perpetual calendar program for enabling said time display unit to display the accurate time and date.

3. The timepiece as claimed in claim 1, wherein said daylight saving time calculation program of said central processing unit has set therein daylight saving time cycles of different time zones and countries.

4. The timepiece as claimed in claim 1, wherein said time display unit comprises an analog time display device and a liquid crystal display for indicating time respectively.

5. The timepiece as claimed in claim 4, further comprising an adjustment knob and a built-in synchronous motor and transmission gear set selectable for adjusting hour hand, minute hand and second hand of said analog time display device,

6. The timepiece as claimed in claim 4, further comprising a keypad, said keypad having a set button and a selection button for setting time display of said liquid crystal display.

7. The timepiece as claimed in claim 1, wherein said time zone adjustment device has a first contact set and a second contact set, said first contact set having four contacts, said second contact set having six contacts, the contacts of said first contact set and the contacts of said second contact set being respectively selectively connected to said central processing unit, providing one of 24 time zone signals to said central processing unit.

8. A daylight saving time automatic adjustment method used in a timepiece that has installed in a movement thereof a central processing unit, a time zone adjustment device and a time display unit, said central processing unit having installed a time zone calculation program and a daylight saving time calculation program, said time zone adjustment device being operable to input one of a set of time zone signals to said central processing unit for enabling said time zone calculation program of said central processing unit to calculate the conversion time corresponding to the set time zone and for enabling said daylight saving time calculation program to determine whether the set time zone has applied daylight saving time, the daylight saving time automatic adjustment method including the steps of:
(A) Start;
(B) Enter normal operation mode;
(C) Judge if minute counting has reached hour status or not, and then proceed to step (D) if positive, or return to step (B) if negative;
(D) Judge if the current time and date are in the daylight saving time cycle or not, and then proceed to step (E) if positive, or step (B) if negative;
(E) Determine if to switch on or switch off the setting of daylight saving time, and then proceed to step (F) when daylight saving time is on, or step (G) when daylight saving time is off;
(F) Advance the present time 1 hour, for enabling the central processing unit to control the time display unit to display the advanced time, and then proceed to step (I);
(G) Judge, subject to the currently running time and date, if the daylight saving time cycle has been ended, and then proceed to step (H) if positive, or return to step (B) if negative;
(H) Adjust current time 1 hour backwards for enabling the time display unit to display adjusted time, and then enter step (I); and
(I) End the procedure.

9. The daylight saving time automatic adjustment method as claimed in claim 8, wherein said central processing unit further has installed therein a perpetual calendar program, said perpetual calendar program including calculation of leap year calculation of leap year/leap month such that when the user sets the present time and date after zeroed the reading of the timepiece, the setting is compared to said perpetual calendar program for enabling said time display unit to display the accurate time and date.

10. The daylight saving time automatic adjustment method as claimed in claim 8, wherein said daylight saving time calculation program of said central processing unit has set therein daylight saving time cycles of different time zones and countries.

11. The daylight saving time automatic adjustment method as claimed in claim 8, wherein said time display unit comprises an analog time display device and a liquid crystal display for indicating time respectively.

12. The daylight saving time automatic adjustment method as claimed in claim 8, wherein said time zone adjustment device has a first contact set and a second contact set, said first contact set having four contacts, said second contact set having six contacts, the contacts of said first contact set and the contacts of said second contact set being respectively selectively connected to said central processing unit, providing one of 24 time zone signals to said central processing unit.
